(19) United States
(12) Patent Application Publication
(10) Pub. No.: US 2026/0358496 A1
(43) Pub. Date: Nov. 12, 2026

(54) Method and Apparatus for Detecting an Object in a Near Region of an Ultrasonic Transducer

(71) Applicant: Elmos Semiconductor SE, Leverkusen (DE)

(72) Inventors: Johann Ott, Dortmund (DE); Stefanie Heppekausen, Essen (DE); Tim Kranemann, Herne (DE)

(21) Appl. No.: 19/667,761

(22) Filed: May 5, 2026

(30) Foreign Application Priority Data
May 7, 2025 (EP) 25174776.2

(51) Int. Cl. G01S 15/04; G01S 15/00; G01S 15/931

(52) U.S. Cl. CPC G01S 15/04; G01S 15/006; G01S 15/931; G01S 2015/932

(57) ABSTRACT

A method for detecting an object in a near region of an ultrasonic transducer, in particular as a parking aid for a vehicle. The method includes the steps of emitting an ultrasonic signal by an ultrasonic transducer into a detection region to be monitored; receiving, by the ultrasonic transducer, an ultrasonic signal reflected by an object in the detection region in the form of an ultrasonic reception signal; determining a phase derivative of the ultrasonic reception signal at least for a near-field region of the ultrasonic reception signal; determining a statistical measure of the phase derivative for the near-field region; and comparing the statistical measure of the phase derivative with a reference value, wherein the presence of an object in the near region of the ultrasonic transducer is inferred on the basis of this comparison.

### CROSS-REFERENCE TO RELATED APPLICATION

This application claims priority to European Patent Application No. 25174776.2 filed May 7, 2025, the disclosure of which is hereby incorporated by reference in its entirety.

### BACKGROUND OF THE INVENTION

### Field of the Invention

The present invention relates to a method for detecting an object in a near region of an ultrasonic transducer, in particular as a parking aid for a vehicle. The present invention particularly relates to a method in which an object in the near region of the ultrasonic transducer is detected by means of a statistical measure. The present invention further relates to a device for implementing such a method, as well as to a system comprising at least one ultrasonic transducer and such a device.

### Description of Related Art

The detection of an obstacle particularly in the surroundings of a vehicle by means of analyzing a received echo signal from previously emitted ultrasonic waves is known in principle. Such methods have proven effective in automotive applications, for example as a parking aid.

In such methods, usually an ultrasonic transducer is used, which is excited to emit an ultrasonic signal into a detection region to be monitored. The ultrasonic signal is then reflected by an obstacle in the detection region and so returns to the ultrasonic transducer. The ultrasonic transducer is then excited by the reflected ultrasonic reception signal, wherein this excitation of the ultrasonic transducer is used as a measurement signal for detecting the obstacle in the detection region.

In particular, in case of very close obstacles, which are located at a small distance from the ultrasonic transducer, the reflected ultrasonic reception signal can return to the ultrasonic transducer already during the excitation of the ultrasonic transducer that generated the originally emitted ultrasonic signal, or during a ring-down time, during which the vibration/oscillation of the ultrasonic transducer generating the ultrasonic signal decays or rings down after the end of the excitation. Thus, the oscillation of the ultrasonic transducer caused by the active excitation and by the ring-down vibration after the end of the excitation overlaps with the reflected ultrasonic reception signal, which has so far rendered the acquisition of the ultrasonic reception signal and thus the detection of an obstacle impossible or barely possible.

### SUMMARY OF THE INVENTION

The object of the invention is to provide a method for detecting an obstacle or object in a near region of an ultrasonic transducer.

This object is achieved by a method, a device, a system, and a computer-readable storage medium described herein.

The method according to the invention for detecting an object or obstacle in a near region of an ultrasonic transducer, in particular as a parking aid for a vehicle, comprises the following steps of:
emitting an ultrasonic signal by an ultrasonic transducer into a detection region to be monitored,
receiving, by the ultrasonic transducer, an ultrasonic signal reflected by an object in the detection region in the form of an ultrasonic reception signal,
determining a phase derivative of the ultrasonic reception signal at least for a near-field region of the ultrasonic reception signal,
determining a statistical measure of the phase derivative for the near-field region, and
comparing the statistical measure of the phase derivative with a reference value, wherein the presence of an object in the near region of the ultrasonic transducer is inferred on the basis of this comparison.

According to the method of the present invention, first an ultrasonic signal is emitted by the ultrasonic transducer into the detection region to be monitored. This is particularly a burst signal emitted by the ultrasonic transducer. If an obstacle is present in the detection region of the ultrasonic transducer, parts of the ultrasonic signal are reflected back to the ultrasonic transducer and are received by the ultrasonic transducer in the form of an ultrasonic reception signal. In particular, the ultrasonic reception signal comprises both a near-field region and a far-field region. In this context, particularly the near-field region overlaps at least partially with a ring-down region of the ultrasonic transducer. After the end of the excitation of the ultrasonic transducer, the ultrasonic transducer continues to oscillate for a certain time. This time is referred to as the ring-down region, or decay region, and usually lasts a few hundred microseconds and in particular less than 1.5 ms. In particular, the ring-down region lasts between 300 μs and 800 μs. In the ring-down region of the ultrasonic transducer, it is still in motion due to the ringing-down excitation. Thus, if there is an obstacle in the near region of the ultrasonic transducer, the ultrasonic signal returns to the ultrasonic transducer within a very short time due to the short propagation time in such a way that the excitation of the ultrasonic transducer caused by the reflected ultrasonic signal overlaps with the ringing-down motion of the ultrasonic transducer. When this is the case, the ringing-down oscillation of the ultrasonic transducer is disturbed by the reflected ultrasonic signal received by the ultrasonic transducer.

Accordingly, this disturbance is detected according to the present invention by means of a statistical measure for detecting an obstacle in the near region of the ultrasonic transducer.

The phase of the reception signal is understood, in particular, as the phase of the band-limited reception signal demodulated into the baseband, which corresponds to a deviation of the reception frequency in a time window with respect to the center frequency of the emission signal and is typically referred to as a complex baseband signal (IQ data). In this context, the reception signal can be filtered rather in a narrowband manner or rather in a broadband manner before demodulation. It has been shown here that the phase derivative of the ultrasonic reception signal, i.e. the derivative of the phase of the ultrasonic reception signal, can be used in particular for detecting an object in the near region of the ultrasonic transducer. Thus, according to the present invention, a statistical measure of the phase derivative for the near-field region of the ultrasonic reception signal is determined and this statistical measure determined in this way is compared with a reference value. On the basis of this comparison, the presence of an obstacle or object in the near region of the ultrasonic transducer is inferred. If the oscillation of the ultrasonic transducer changes in its ring-down region due to an ultrasonic signal reflected in the near region of the ultrasonic transducer, the statistical measure changes and deviates from the reference value, so that the presence of an object in the near region of the ultrasonic transducer can be reliably inferred. The phase of the ultrasonic reception signal is in this context sensitive to external influences, such as an ultrasonic reception signal reflected from an obstacle in the near region of the ultrasonic transducer. By using the derivative of the phase to determine the statistical measure, changes in the phase can be determined so that objects in the near region of the ultrasonic transducer can be detected reliably and with high accuracy. Furthermore, based on the comparison with a reference value, no storage of the phase derivative and/or of the ultrasonic reception signal is required, so that an object or obstacle in the near region of the detection region can be reliably detected in one measurement cycle only.

Preferably, the near-field region at least partially comprises the ring-down region of the ultrasonic transducer. The near-field region of the ultrasonic reception signal thus denotes the temporal section of the ultrasonic reception signal, which comprises in particular at least partially the duration of the ring-down or decay of the ultrasonic transducer.

In order to arrive at a more reliable detection result, the evaluation of the phase can preferably take place in a plurality of frequency bands, with a near-range object detection being performed in each frequency band. The detections obtained can then be combined using a statistical method particularly, to form an overall detection result. For example, an object is considered detected if a near-range object is detected in at least one frequency band or if a positive detection result is achieved in a certain number of frequency bands. The frequency bands may also overlap.

Preferably, a (standardized) higher-order central moment is generally used as a statistical measure. Preferably, what is meant by the statistical measure is kurtosis, logarithmic kurtosis, or the Hoover index. In particular, the kurtosis w is calculated as

$$ω = \frac{1}{n} {\sum }_{i = 1}^{n} {( \frac{{x}_{i} - \overline{x}}{s} )}^{4} ,$$

wherein xᵢ denotes the values of the phase derivative, x̅ denotes the arithmetic mean and s denotes the standard deviation.

In particular, the logarithmic kurtosis is calculated as ld(ω), where ld denotes the logarithm to base 2.

Particularly, the Hoover index H is determined as

$$H = \frac{1}{2} \frac{{\sum }_{i} \vert {x}_{i} - \overline{x} \vert}{{\sum }_{i} {x}_{i}} .$$

Particularly, when using kurtosis or logarithmic kurtosis, it has been shown that these are sensitive to a change in the phase derivative in such a way that an influence on the decay behavior of the ultrasonic transducer by a reflected ultrasonic signal can be detected in a reliable manner. Since kurtosis or logarithmic kurtosis is normalized to the standard deviation, external influences on the result can be reduced. Thus, the use of kurtosis or logarithmic kurtosis or the Hoover index ensures a robust detection of the obstacle in the near region of the ultrasonic transducer.

An online algorithm, such as the Welford's online algorithm, is preferably used to determine the statistical measure. In this context, the statistical measure can be determined online, i.e. without intermediate storage, in a single pass, and thus it is not necessary to store all values in the near-field region of the ultrasonic reception signal. This makes it possible to calculate the statistical measure in real time. This ensures a rapid detection of an obstacle in the near region of the ultrasonic transducer. Likewise, it is not necessary to provide a corresponding memory. In particular, kurtosis or logarithmic kurtosis is determined online, i.e. in a single pass, in particular without storing the entire values of the ultrasonic reception signal or its phase derivative. Preferably, the method is an algorithm according to Timothy B. Terriberry, “Computing Higher-Order Moments Online” or Pébay, Philippe Pierre, “Formulas for Robust, One-Pass Parallel Computation of Covariances and Arbitrary-Order Statistical Moments”.

Preferably, at least one evaluation window is defined in the near-field region of the ultrasonic transducer, in which the statistical measure of the phase derivative is determined. In particular, the statistical measure of the phase derivative is determined only in the evaluation window. Thus, the determination of the statistical measure and/or the determination of the phase derivative can be limited to the evaluation window. In this way, the determination of the statistical measure can be limited to the relevant region of the ultrasonic reception signal. This can reduce the required computing power. This also ensures that the statistical measure is not influenced by an echo signal in the far-field region of the ultrasonic reception signal.

Preferably, the position and width of the evaluation window are selected as a function of one or more of the decay time of the ultrasonic transducer, the temperature, the excitation current of the ultrasonic transducer, the quality factor of the ultrasonic transducer, the excitation frequency of the ultrasonic transducer, the number of excitation pulses of the ultrasonic transducer, and the excitation duration of the ultrasonic transducer. In particular, the evaluation window can begin with the excitation of the ultrasonic transducer. Preferably, the evaluation window begins at the end of the excitation of the ultrasonic transducer, i.e. at the beginning of the ring-down region of the ultrasonic transducer. Preferably, the evaluation window ends after the end of the ring-down region of the ultrasonic transducer. Thus, in particular the position and the width of the evaluation window are based on the ring-down region, which can be influenced by the parameters mentioned above.

Preferably, the phase derivative is determined from the IQ values of the ultrasonic reception signal. In particular, the phase derivative φ′(n) is determined according to φ′(n)=I(n−1)·(Q(n−2)−Q(n))−Q(n−1)·(I(n−2)−I(n)), wherein n denotes a discrete time step, I denotes the in-phase values and Q denotes the quadrature values of the ultrasonic reception signal. Thus, the phase derivative φ′(n) is particularly an approximation which can be simply calculated online, i.e. in a single step using intermediate storage of only a few discrete values of the ultrasonic reception signal.

Preferably, the reference value is the same statistical measure of a reference signal. Thus, the same statistical measure is determined for the reference signal as is determined from the phase derivative of the ultrasonic reception signal. For example, if the selected statistical measure is kurtosis, then likewise the kurtosis of the reference signal is determined to determine the reference value.

Preferably, to determine the reference value, the ultrasonic transducer is excited using a reference excitation signal, and a reference signal is detected in the absence of reflections from an obstacle in the reception range. Thus, the reference signal is an undisturbed oscillation of the ultrasonic transducer. This can be achieved by ensuring that there is no object or obstacle in the near region of the ultrasonic transducer. Thus, the ultrasonic transducer undergoes an undisturbed ring-down after the end of the reference excitation signal.

Preferably, to determine the reference value, a reference excitation signal is selected such that the acoustic transmission path can be neglected. Thus, to determine the reference value, it is either ensured that there is no obstacle in the near region of the ultrasonic transducer and thus no reflection returns to the ultrasonic transducer. Or alternatively, the reference excitation signal is selected to be so small that the excitation of the ultrasonic transducer would not be sufficient to generate reflections from an obstacle in the near region of the ultrasonic transducer, which could have an influence on the ring-down behavior of the ultrasonic transducer. The ultrasonic signal, which is generated by the excitation of the ultrasonic transducer with the reference excitation signal, does not interact or interacts only insignificantly with the ultrasonic transducer and, in particular, has no influence or only a negligible influence on the ring-down behavior of the ultrasonic transducer. If the ultrasonic transducer is excited for an actual measurement, for example, using a current of several hundred milliamperes, the reference excitation signal can have an excitation current of less than 200 μA and in particular less than 10 μA, so that the ultrasonic signal generated will not be sufficient for detecting reflections from an obstacle in the near region of the ultrasonic transducer. In particular, the reference excitation signal is between 1 μA and 150 μA. The reference excitation signal is particularly smaller by a factor of 1000 than the excitation signal for emitting the ultrasonic signal of the actual measurement. Therefore, the acoustic transmission path is negligible in this case.

Preferably, the statistical measure for the reference value is determined from a phase derivative of the reference signal. Thus, the reference value is determined in the same way as the statistical measure of the ultrasonic reception signal in an actual measurement.

Preferably, exactly one ultrasonic signal is emitted per measurement cycle. In particular, a reference excitation signal can additionally be generated within the measurement cycle. Thus, objects in the near region as well as in the far region of the ultrasonic transducer can be detected with only one ultrasonic signal. A separate near-field mode or the like is thus not required.

Preferably, the reference value is determined once per measurement or measurement cycle. In this context, for example, the reference excitation signal can be generated immediately after or immediately before the actual measurement. In particular, the reference excitation signal can be generated immediately before a measurement cycle or immediately after a measurement cycle to determine the reference value. In doing so, the generation of the reference excitation signal is particularly temporally separated from the generation of the ultrasonic signal of the actual measurement and from the reception of the ultrasonic reception signal. Thus, a current reference value is always available for comparison. External influences, such as temperature, also affect the reference value and therefore do not influence the detection result or do not need to be separately detected and taken into account. This provides a particularly robust method for detecting objects in the near region of an ultrasonic transducer.

Alternatively, the reference value is determined once per activation of the system. If, for example, a user activates the obstacle detection feature during a parking instance, for example, the reference value can be determined once upon system activation and then used for the plurality of measurements during the time in which the system remains continuously activated.

Alternatively, the reference value is determined once for each system. Thus, the reference value can be determined once, for example, when the system is installed in a vehicle. In this way, deviations due to the combination of individual components, variations in mounting orientation, and system noise, for example, can be accounted for by the reference value. Alternatively, the reference value is determined once for a specific system. Here, a specific system refers to the combination of components of the same type, such as the ultrasonic transducer and the implementing devices, as described below. In this way, a reference value can be determined for this specific system, and the reference value can then be used for all similar systems when detecting an obstacle in the near region of the respective ultrasonic transducer.

Preferably, if a difference between the statistical measure of the phase derivative and the reference value is greater than a predefined limit value, the presence of an obstacle is inferred. In particular, if a difference between the statistical measure of the phase derivative and the reference value is greater than a predefined limit value, a flag is set in a signal path, particularly within the vehicle, so that the information about an obstacle in the near region of the ultrasonic transducer can be forwarded. Alternatively or additionally to using a flag, the difference value between the statistical measure and the reference value, or other values determined within the scope of this method, can be transmitted, such as the phase derivative or the like, or variables derived therefrom, such as a mean value of the difference value in the evaluation window or the like.

Preferably, when an object is detected in the near region of the ultrasonic transducer, i.e. when a flag is set, this information is output to a user, for example as a warning signal, or is output to a higher-level system to be processed further. The warning signal can be an optical warning signal, for example, on a display. Alternatively or additionally, it can be an acoustic warning signal and/or a haptic warning signal.

In a further aspect of the present invention, a device is provided, which is particularly configured in the form of a microelectronic circuit. The device is configured for connection to at least one ultrasonic transducer. The device comprises a memory unit and a processor, wherein the memory unit stores instructions which, when executed by the processor, implement the steps of the method described above.

Preferably, the microelectronic circuit is an integrated circuit, or an application-specific integrated circuit (ASIC), or an FPGA, or the like.

In a further aspect of the present invention, a system is provided, which comprises a device as described above and at least one ultrasonic transducer, which is connected to this device.

In a further aspect of the present invention, a computer-readable storage medium is provided, which comprises commands that, when executed by a processor, particularly by a processor of a system as described above, cause it to implement the method described above.

### BRIEF DESCRIPTION OF THE DRAWINGS

The invention is explained in more detail below on the basis of preferred embodiments with reference to the attached figures.

In the figures:

FIG. 1 shows a schematic flow diagram of the method according to the present invention;

FIG. 2 shows a first embodiment of the method according to the present invention;

FIG. 3 shows a further embodiment of the method according to the present invention;

FIGS. 4A and 4B show a schematic illustration for determining a reference value;

FIGS. 5A and 5B show a schematic illustration of a measurement; and

FIG. 6 shows a system according to the present invention.

### DESCRIPTION OF THE INVENTION

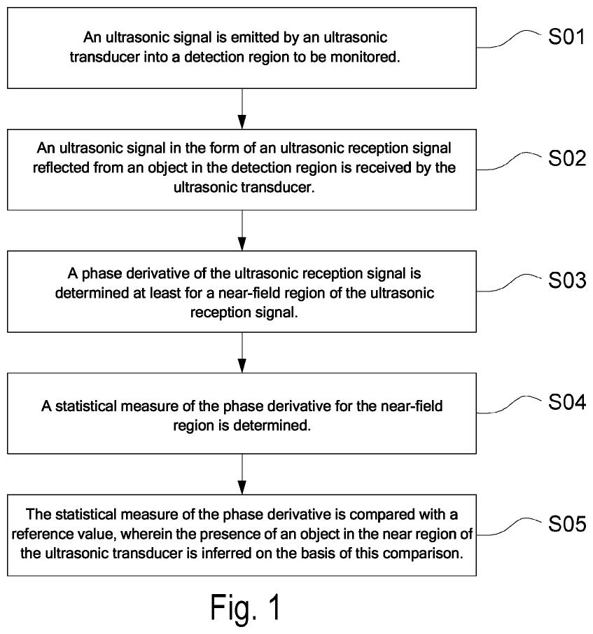

In the following, reference is made to FIG. 1. FIG. 1 shows a schematic flow diagram of the method according to the present invention for detecting an object in a near region of an ultrasonic transducer, in particular as a parking aid for a vehicle, comprising:
a step S01, wherein an ultrasonic signal is emitted by an ultrasonic transducer into a detection region to be monitored;
a step S02, wherein an ultrasonic signal reflected by an obstacle in the detection region is received by the ultrasonic transducer in the form of an ultrasonic reception signal;
a step S03, wherein a phase derivative, i.e. a derivative of the phase of the ultrasonic reception signal is determined at least for a near-field region of the ultrasonic reception signal;
a step S04, wherein a statistical measure of the phase derivative for the near-field region is determined;
a step S05, wherein the statistical measure of the phase derivative is compared with a reference value, wherein the presence of an obstacle in the near region of the ultrasonic transducer is inferred on the basis of this comparison.

The present invention thus detects the disturbance of the ringing-down oscillation of the ultrasonic transducer caused by an ultrasonic signal reflected from an object in the near region of the ultrasonic transducer using a statistical measure for detecting the object in the near region of the ultrasonic transducer.

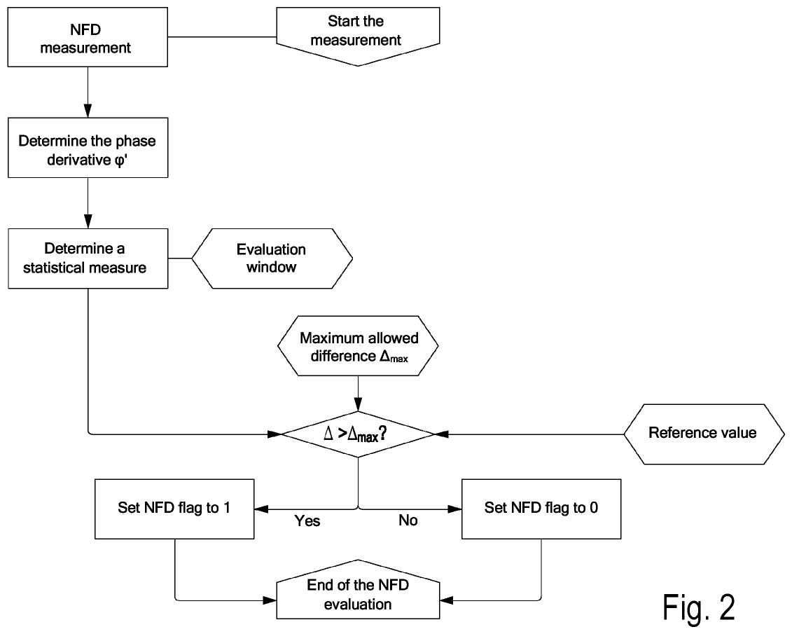

In the following, reference is made to FIG. 2. FIG. 2 shows a flow diagram for detecting an object in the near region of an ultrasonic transducer. First, a measurement cycle is initiated. Here, the measurement cycle can comprise only a near-field detection (NFD) measurement, which is designed only for detecting an object in the near region. Alternatively, the measurement or the measurement cycle can comprise the detection of objects both in the near region and in the far region of the ultrasonic transducer. In particular, an advantage of the present invention is that no separate NFD mode is required, and objects in both the near and far regions can be detected within the same measurement cycle using the same ultrasonic signal. In the following, the present method is described only with reference to an NFD measurement. However, this is not to be construed as limiting the present invention, such that, in addition to the NFD measurement, a far-range detection measurement can be conducted simultaneously within the same measurement cycle. The detection of objects in the far region of an ultrasonic transducer is well known.

For the NFD measurement, an ultrasonic signal is emitted by an ultrasonic transducer into a detection region to be monitored according to step S01. The emitted ultrasonic signal is reflected from an obstacle in the detection region and is detected by the ultrasonic transducer in the form of an ultrasonic reception signal according to step S02. Subsequently, the phase derivative φ′(n) of the ultrasonic signal is determined. In this context, the determination of the phase derivative φ′ can be determined only for a certain region of the ultrasonic reception signal or for the entire ultrasonic reception signal. What is meant here with the phase derivative φ′ is particularly an approximation of the phase derivative. The phase derivative φ′(n) is particularly determined according to

φ′(n)=I(n−1)·(Q(n−2)−Q(n))−((n−1)·(I(n−2)−I(n))

wherein n denotes a discrete time step, I denotes the in-phase values and Q denotes the quadrature values of the ultrasonic reception signal.

Then, a statistical measure is determined in a predefined evaluation window from the phase derivative φ′. What is meant here by the statistical measure is particularly kurtosis, logarithmic kurtosis, or the Hoover index. The statistical measure is compared with a reference value. For this purpose, in particular the difference A is determined from the predefined limit value and the determined statistical measure. The difference A is then compared with a maximum permitted difference Amax as a threshold. If the statistical measure is greater than a predefined limit value or the difference from the reference value is greater than the predefined threshold, an indication signal is set, for example, as an NFD flag. The indication signal indicates that an obstacle or object is present in the near region of the ultrasonic transducer.

The use of the phase derivative, instead of the ultrasonic reception signal itself, for determining the statistical measure makes the method highly sensitive and thus enables reliable detection of objects in the near region of the ultrasonic transducer. Furthermore, based on the comparison with a reference value, no storage of the phase derivative and/or of the ultrasonic reception signal is required, so that an object or obstacle in the near region of the detection region can be reliably detected in only one measurement.

What is meant here by the statistical measure is particularly kurtosis or logarithmic kurtosis. It has been shown that kurtosis or logarithmic kurtosis is sensitive to changes in the phase derivative, thereby enabling reliable detection of an influence on the decay behavior of the ultrasonic transducer caused by a reflected ultrasonic signal. Since kurtosis or logarithmic kurtosis is normalized to the standard deviation, external influences on the result can be reduced. Thus, the use of kurtosis or logarithmic kurtosis provides a robust method for detecting an obstacle in the near region of the ultrasonic transducer.

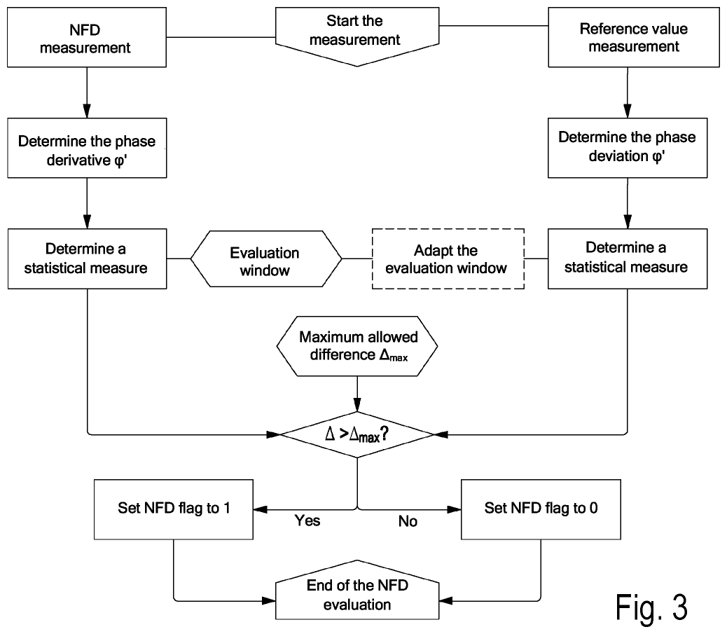

In the following, reference is made to FIG. 3. In this case, the NFD measurement is conducted analogously to FIG. 2 described above. However, a reference value is now determined in parallel. In particular, a reference signal measurement is also made at the start of the measurement. Here, a reference signal is generated by excitation of the ultrasonic transducer in the absence of detected reflections from an obstacle or object in the reception range. On the one hand, this can be achieved in the absence of obstacles in the detection region of the ultrasonic transducer. Alternatively, the excitation of the ultrasonic transducer can be selected in such a manner that the acoustic transmission path is negligible or, if an obstacle is present in the detection region of the ultrasonic transducer, reflections from this obstacle have no or only a slight effect on the ring-down behavior of the ultrasonic transducer. In particular, the reference signal is the undisturbed ring-down signal of the ultrasonic transducer.

The reference signal is then used to determine a phase derivative φ′. In particular, the phase derivative φ′ is determined analogously to the phase derivative of the NFD measurement. Here, particularly the same equation is used. Then, a statistical measure of the phase derivative φ′ is determined in an evaluation window as a reference value. This is the same statistical measure as that used for the NFD measurement. For example, if kurtosis is used in the NFD measurement, then it is also used for determining the reference value. In particular, the evaluation window can be adapted when the reference value is determined. Here, the evaluation window can be adapted to the reduced excitation current of the ultrasonic transducer for detecting the reference signal. However, this is an optional step as indicated by the dashed lines in FIG. 3.

The rest of the method proceeds analogously to the method described in FIG. 2. Thus, according to the method of FIG. 3, a separate reference value is determined in each measurement cycle, which is used to detect an object in the near region of the ultrasonic transducer. Thus, an object in the near region of the ultrasonic transducer can already be detected within a measurement cycle. A single measurement is therefore sufficient. In particular, it is not necessary to detect changes in signals from different measurement cycles and to compare them with one another, which would require storage, whereby the measurement duration until an object in the near region of the ultrasonic transducer can be detected would also involve at least two measurement cycles.

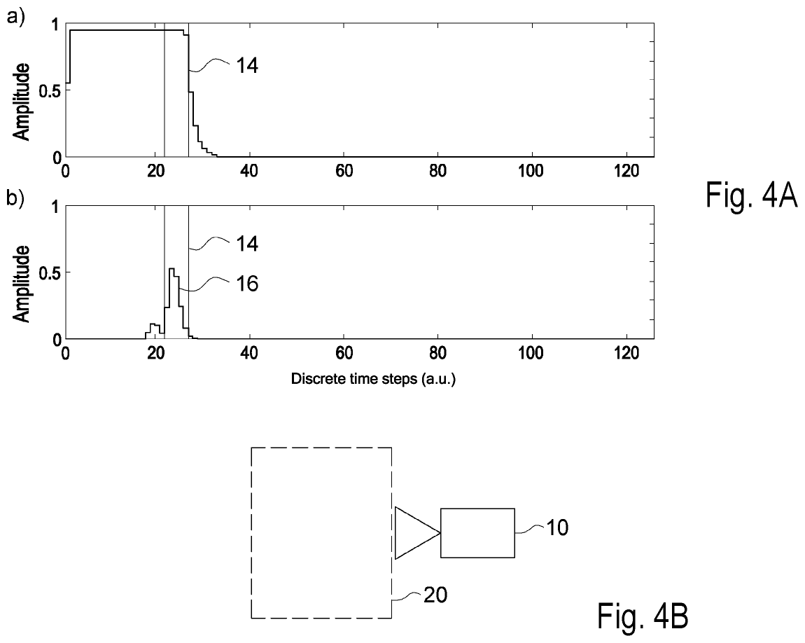

FIGS. 4A and 4B illustrate the reference signal measurement for determining the reference value. Here, FIG. 4Aa) illustrates the signal, or its envelope 12, as detected by the ultrasonic transducer 10. No object is present in the near region 20 according to FIG. 4B. Alternatively, as already described above, the ultrasonic transducer 10 can emit such a weak signal that, even if an object were present in the near-field region of the ultrasonic transducer 10, the ultrasonic signal emitted by the ultrasonic transducer 10 would be so weak that reflections from the object would have no influence on the ultrasonic transducer 10 and, in particular, would have no influence on the ring-down behavior of the ultrasonic transducer 10. Furthermore, in FIG. 4Ab), the phase derivative 14 of the reference signal 12 is illustrated. Here, the statistical measure of the phase derivative 16 is determined in the evaluation window 14. This value is used as the reference value for detecting an object in the near-field region 20 of the ultrasonic transducer 10.

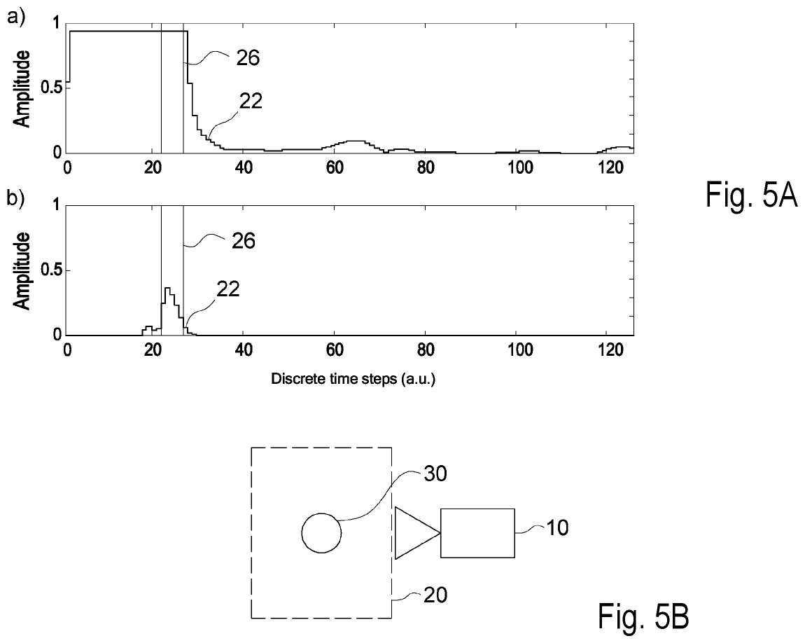

In the following, reference is made to FIGS. 5A and 5B. An object 30, as schematically illustrated in FIG. 5B, is now present in the near-field region 20 of the ultrasonic transducer 10. An ultrasonic signal is emitted by the ultrasonic transducer 10, wherein reflections of the ultrasonic signal are received by the ultrasonic transducer 10 in the form of an ultrasonic reception signal. The ultrasonic reception signal received by the ultrasonic transducer is illustrated in FIG. 5Aa) in the form of an envelope 22. Since the object 30 is located in the near region 20 of the ultrasonic transducer, the ultrasonic signal reflected from the object 30 and received by the ultrasonic transducer 10 will have an influence on the ring-down behavior of the ultrasonic transducer. The phase derivative 24 thereof is shown in FIG. 5Ab). Here, the statistical measure is determined in the evaluation window 26 and compared with the reference value determined according to FIGS. 4A and 4B. It is not apparent from the envelope 22 alone whether or not an obstacle or an object 30 is present in the near region 20 of the ultrasonic transducer. However, based on the phase derivative, the presence of the obstacle or object 30 can be reliably inferred by taking into account the determined statistical measure or the deviation of the statistical measure between the reference signal and the NFD measurement.

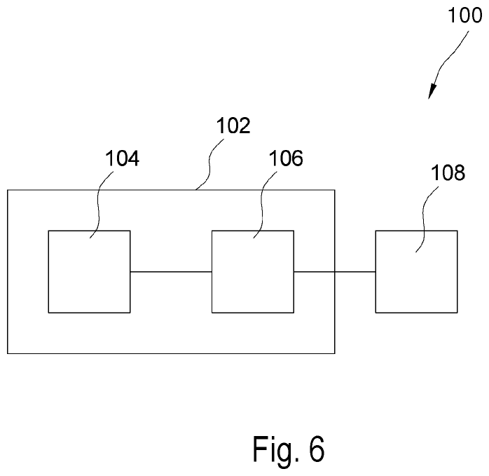

In the following, reference is made to FIG. 6. FIG. 6 shows a system 100 comprising a device 102. The device 102 comprises a memory unit 104 as well as a processor 106. The device 102 is connected to an ultrasonic transducer 108. Optionally, more than one ultrasonic transducer 108 can be provided. Instructions are stored in the memory unit 104 which, when executed by the processor 106, implement the steps of the method described above.

Thus, a method, a device, and a system are provided by means of which the change in the ring-down behavior of the ultrasonic transducer is detected by means of a statistical measure of the phase derivative and is compared with a reference value. In this way, a robust, reliable, and easy-to-implement method is provided to detect objects or obstacles in the near region of the ultrasonic transducer using only a single measurement.

1. A method for detecting an object in a near region of an ultrasonic transducer, in particular as a parking aid for a vehicle, comprising the steps of:
emitting an ultrasonic signal by an ultrasonic transducer into a detection region to be monitored;
receiving, by the ultrasonic transducer, an ultrasonic signal reflected by an object in the detection region in the form of an ultrasonic reception signal;
determining a phase derivative of the ultrasonic reception signal at least for a near-field region of the ultrasonic reception signal;
determining a statistical measure of the phase derivative for the near-field region; and
comparing the statistical measure of the phase derivative with a reference value, wherein the presence of an object in the near region of the ultrasonic transducer is inferred on the basis of this comparison.

2. The method according to claim 1, wherein the near-field region comprises at least partially a ring-down region of the ultrasonic transducer.

3. The method according to claim 1, wherein the statistical measure is kurtosis, logarithmic kurtosis, or the Hoover index.

4. The method according to claim 1, wherein an online algorithm is used to determine the statistical measure.

5. The method according to claim 1, wherein one or more evaluation windows are defined in the near-field region of the ultrasonic transducer, wherein the statistical measure of the phase derivative is determined only in the one or more evaluation windows.

6. The method according to claim 5, wherein the position and width of one or more evaluation windows are selected as a function of one or more of the following parameters: decay time of the ultrasonic transducer, the temperature, the excitation current of the ultrasonic transducer, the quality factor of the ultrasonic transducer, the excitation frequency of the ultrasonic transducer, the number of excitation pulses, and the excitation duration of the ultrasonic transducer.

7. The method according to claim 1, wherein the phase derivative is determined on the basis of IQ values of the ultrasonic reception signal.

8. The method according to claim 7, wherein the phase derivative φ′(n) is determined according to
φ′(n)=I(n−1)·(Q(n−2)−Q(n))−Q(n−1)·(I(n−2)−I(n)),
wherein n denotes a discrete time step, I denotes the in-phase values and Q denotes the quadrature values of the ultrasonic reception signal.

9. The method according to claim 1, wherein, in order to determine the reference value, the ultrasonic transducer is excited with a reference excitation signal in the absence of an obstacle in the detection region or at least in the absence of an obstacle in the near region of the ultrasonic transducer, and a reference signal is detected by the ultrasonic transducer.

10. The method according to claim 1, wherein, in order to determine the reference value, the ultrasonic transducer is excited with a reference excitation signal, and a reference signal is detected by the ultrasonic transducer, wherein the ultrasonic signal, which is generated by excitation of the ultrasonic transducer with the reference excitation signal, does not interact with any possible near or far objects and is therefore independent of objects in front of the ultrasonic transducer.

11. The method according to claim 9, wherein the reference signal is an undisturbed ring-down signal of the ultrasonic transducer.

12. The method according to claim 1, wherein the reference value is determined once per measurement, once per activation of the system, once for each system or once for a specific system.

13. The method according to claim 1, wherein the presence of an obstacle is inferred if a difference between the statistical measure of the phase derivative and the reference value is greater than a predefined limit value.

14. A device for connection to at least one ultrasonic transducer, wherein the device comprises a memory unit and a processor, wherein the memory unit stores instructions which, when executed by the processor, implement the steps of the method according to claim 1.

15. A system comprising a device according to claim 14 and at least one ultrasonic transducer, which is connected to this device.

16. A computer-readable storage medium comprising commands that, when executed by a processor, cause the processor to implement the method according to claim 1.
